(19) United States
(12) Patent Application Publication
(10) Pub. No.: US 2005/0282920 A1
(43) Pub. Date: Dec. 22, 2005

(54) High multiple foam manufacturing method for thermoplastic elastomers composites

(75) Inventor: Chun-Hsiung Wu, Tainan City (TW)

Correspondence Address: BACON & THOMAS, PLLC, 625 SLATERS LANE, FOURTH FLOOR, ALEXANDRIA, VA, 22314, US

(73) Assignee: MICROCELL COMPOSITE COMPANY, Tainan City (TW)

(21) Appl. No.: 11/119,897

(22) Filed: May 3, 2005

(30) Foreign Application Priority Data
Jun. 21, 2004 (TW) 093117925

(51) Int. Cl. C08J 3/00

(52) U.S. Cl. 521/54

(57) ABSTRACT

The present invention is to provide a high multiple foam manufacturing method, which uses a thermoplastic elastomer as a substrate, adds a foaming agent and a cross-linker having different functions, and uses traditional devices for a kneading and a laminating processes to produce laminates of an appropriate size. The laminates are stacked with each other and then sent into the first section of a hot compression mold for the first-time compression molding and foaming. The pre-foaming cast so obtained is sent into a second section of the hot compression mold for a second-time compression mold foaming or a normal pressure foaming to produce the high multiple foam having the advantages of general plastic and rubber foams at the same time.

### FIELD OF THE INVENTION

The present invention relates to a foam manufacturing method, and more particularly to a high multiple foam manufacturing method utilizing traditional two-section chemical cross-linking foaming technology and devices to produce a high multiple foam, having the advantages of general plastic and rubber foams at the same time, by a thermoplastic elastomer composite without substantially changing the conditions of the existing manufacturing process.

### BACKGROUND OF THE INVENTION

Traditional foams are divided generally into plastic foams and rubber foams according to the material used. Although the two-section chemical cross-linking foaming process and related products for these foam materials are quite mature, the fields of their applications are not the same, since the material properties of these foams are different. For example, traditional plastic foams generally use a dopant such as Ethylene Vinyl Acetate (EVA) or a mixture of EVA and Polyethylene (PE) as its main constituents. In a traditional plastic two-section chemical cross-linking foaming process, the dopant is mixed by a kneader and milled by a two-roll mill and then cut into laminates of an appropriate size by a laminating machine. The laminates are stacked and then sent into the first section of a hot-pressing mold for a first-time foaming, and the pre-foaming cast so obtained is put into a second section of the hot-pressing mold of another predetermined specification when the pre-foaming cast is still hot for a second-time foaming, so as to produce the required high multiple plastic foam. In addition to the advantages of having an easy manufacturing process at a later stage and forming finished products with a complicated shape, this kind of plastic foams also features the advantages of a high buoyancy, a high insulation and a high damping function, and thus the plastic foam is commonly used for making products such as life buoys, surfboards, and thermal insulating tubes, and its disadvantages include poor elasticity and low slip resistance incompliant to our requirements.

As to the prior art rubber foams, a rubber dopant such as Styrene Butadiene Rubber (SBR) and Chloroprene Rubber (CR) is used as its main constituent. In a traditional rubber two-section chemical cross-linking foaming process, the dopant is mixed by a kneader and milled by a two-roll mill and then cut into laminates of an appropriate size by a laminating machine. The laminates are stacked and sent into the first section of the hot compression mold for a first-time foaming process. In the second-section foaming process, the pre-foaming cast obtained from the first-section foaming process is placed into a rectangular oven having a conveying function, when the pre-foaming cast is still hot. The second-time foaming process is continued and performed at a normal pressure to produce the required high multiple rubber foam. Although this kind of rubber foams can overcome the shortcomings of the plastic foam and have better elasticity, slip resistance and compressibility, the formula for making this kind of rubber foams is more complicated, and its production process produces dusts and causes pollutions to the environment. Additionally, this kind of rubber foams not only has difficulties of forming finished products with a complicated shape during the later stage of the manufacturing process, but also has difficulties to recycle the waste material produced. The foregoing drawbacks are unsolved problems for manufacturers using rubber foams of this sort.

Therefore, finding a way to change the manufacturing process to manufacture a high multiple foam having the characteristics of both the rubber and plastic foams to effectively improve the properties and applications of the foam is an important subject of this invention.

### SUMMARY OF THE INVENTION

In view of the shortcomings and long existing problems of the prior art rubber and plastic foams, the inventor of the present invention based on years of practical experience to conduct researches and develop a high multiple foam manufacturing method for thermoplastic elastomer composites. This method uses a thermoplastic elastomer as the composite of a substrate. After a foaming agent and a cross-linker of different functions are added, traditional devices are used for the kneading and laminating processes to produce laminates of an appropriate size. Stacks of laminates in a certain specific quantity according to actual needs are sent to a first section of the hot compression foaming process, and a pre-foaming cast so obtained is sent into a second section of the hot compression mold or oven for a second-time press-molding foaming process or a normal pressure foaming process to produce a high multiple foam with a foaming multiple of over 15 times.

The primary objective of the present invention is to use traditional two-section chemical cross-linking foaming technology and devices to produce a high multiple foam by a thermoplastic elastomer composite without substantially changing the conditions of the existing manufacturing process.

Another objective of the present invention is to produce a high multiple foam, not only having the high elasticity and slip resistance of a general rubber foam, but also has the advantages of a general plastic foam including an easy formula, an easy coloration, an easy second-time manufacturing and a recycle for environmental protection.

The above and other objects, features and advantages of the present invention will become apparent from the following detailed description taken with the accompanying drawings.

### BRIEF DESCRIPTION OF THE DRAWINGS

FIG. 1 is a flow chart of the manufacturing process of the present invention.

### DETAILED DESCRIPTION OF THE PREFERRED EMBODIMENTS

A high multiple foam manufacturing method for thermoplastic elastomer composites in accordance with the present invention uses a thermoplastic elastomer as the composite of a substrate, and adds a foaming agent and a cross-linker having different functions, and uses traditional devices for a kneading and a laminating processes to produce laminates of an appropriate size. The laminates are stacked with each other into a certain specific quantity according to actual needs and then sent into the first section of a hot compression mold for the first-time compression molding and foaming process. The pre-foaming cast so obtained is sent to the second section of the hot compression mold or oven, when the pre-foaming cast is still hot for a second-time compression mold foaming process or a normal pressure foaming process to produce a foam with a foaming multiple over 15 times. The high multiple foam not only has the good elasticity and slip resistance of a general rubber foam, but also has the advantages of a general plastic foam including its simple formula, easy coloration, easy second-time manufacture and environmental recycle and reuse.

In the present invention, a styrenic thermoplastic elastomer including Styrene Butadiene Styrene (SBS), Styrene Ethylene Butene Styrene (SEBS) or Styrene Isoprene Styrene (SIS) is used as a substrate, and other rubber, thermoplastic elastomer or plastic material is added into the substrate according to a predetermined percentage by weight, and finally a foaming agent, a cross-linker and other auxiliaries according to a predetermined percentage by weight are added to prepare the required thermoplastic elastomer composite of the present invention.

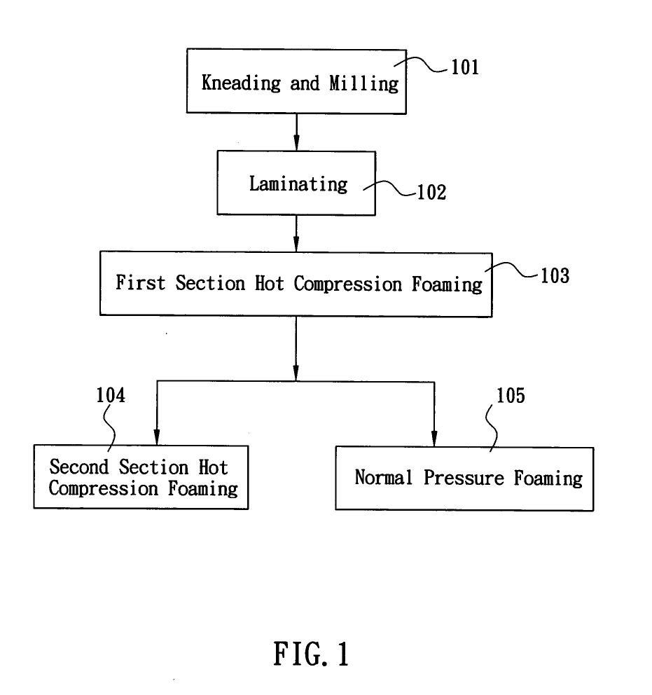

Reference is made to FIG. 1 for the whole manufacturing process in accordance with the present invention. The invention adopts a traditional two-section chemical cross-linking foaming process that uses traditional kneading, laminating and foaming devices to prepare the thermoplastic elastomer composite according to the following procedures, and the kneading, laminating and foaming procedures comprise the steps of:
(101) putting each thermoplastic elastomer composite with a predetermined percentage by weight into a kneader, a two-roll mill or a Banbury mixer, and mixing the composites in the devices at a temperature of approximately 90° C. to 130° C.;
(102) sending the evenly mixed thermoplastic elastomer composites into a two-roll laminating device to carry out a calendaring process, and forming a laminate with the required thickness after several times of the calendaring process, and then using an automatic knife to cut the laminate into laminates of an appropriate size;
(103) selecting the laminates with appropriate quantity and weight according to actual needs, and putting the laminates into a first section of the hot compression mold after the laminates are stacked, so that the hot compression molds are stacked with each other at a temperature of approximately 140° C. to 180° C. and a pressure of approximately 90 Kg/cm² to 250 Kg/cm² for performing a first-time hot compression and a foaming process. An appropriate period of time, depending on the size and thickness of the mold and generally about 10 minutes to 40 minutes, is taken for produce the required pre-foaming cast.

In the second-section foaming process in accordance with the present invention, a mold pressing foaming process or a normal pressure foaming process comprises the steps of:

(104) Putting the foaming cast into the second-section hot compression mold with a predetermined specification when the foaming cast is still hot, if the mold pressing foaming process is adopted, so that the second-section hot compression mold at a temperature of approximately 140° C. to 180° C. and a pressure of approximately 90 Kg/cm² to 250 Kg/cm² performs a foaming process and a second-time hot compression. An appropriate period of time, depending on the size and thickness of the mold and generally about 10 minutes to 40 minutes, is taken to produce the required high performance foam.

(105) If the normal foaming process is adopted, the foaming cast is put into a rectangular oven having a conveying function, so that the rectangular oven at a temperature of approximately 140° C. to 180° C. and a normal pressure performs a second-time foaming process for the foaming cast. An appropriate period of time, depending on the size and thickness of the foaming cast and generally about 10 minutes to 30 minutes, is taken to produce the required high performance foam.

In a preferred embodiment of the present invention, the thermoplastic elastomer composite comprises:

(1) Styrenic thermoplastic elastomer: This constituent is the substrate of the composite and occupies approximately 50% to 100% by weight, and could be a material of SBS, SEBS, SIS, or Styrene Ethylene Propylene Styrene (SEPS).

(2) Chemical foaming agent: This constituent is approximately 5% to 25% by weight and could be a diazo foaming agent.

(3) Cross-linker: This constituent is approximately 0.01% to 0.5% by weight and could be dicumyl peroxide, 2,5-(tert-butylperoxide)-2,5-dimethylhexane, or sulfur.

The inventor of the present invention uses the aforementioned constituents with a traditional two-section chemical cross-linking foaming process to produce a high performance foam of a thermoplastic elastomer easily according to the foregoing manufacturing process. Experiments show that the high performance foam definitely has the following advantages:

(1) The invention can use the traditional two-section chemical cross-linking foaming technology and devices without the need of substantially changing its manufacturing conditions to produce a high performance foam with the characteristics of both rubber and plastic foams.

(2) The foaming multiple of the high performance foam is up to 15 times, and the specific gravity of the foam is below 0.07.

(3) The foam thickness of the high performance foam may exceed 50 mm according to the thickness of the mold.

(4) The high performance foam manufactured by the present invention not only has the features of good elasticity and slip resistance, easy coloration, having no sulfur rubber odor and easy to be recycled and reused, but also effectively broaden the applications of the foam.

(3) Since the foam at its later section of the manufacturing process has a secondary manufacturability and can produce foams with a complicated form or pattern easily, therefore the foam is applicable for embossed, laminating and transfer printing products.

In addition, the composite of the present invention is not limited to the foregoing constituents in its practical applications, but the following constituents can be added to the composite of the thermoplastic elastomer according to the desired functions, features or actual needs to produce the thermoplastic elastomer foam according to the present invention:

(1) Other polymer materials: This constituent is approximately 0% to 50% by weight and could be Styrene Butadiene Rubber (SBR), Polystyrene (PS) EVA, Low Density Polyethylene (LDPE) or Ethylene Propylene Terpolymer Rubber (EPDM) for changing the material properties of the foam in order to meet the requirements of actual needs.

(2) Foaming auxiliaries: This constituent is approximately 0% to 3% by weight and could be zinc oxide or urea used for promoting the foaming effect and speed

(3) Other additives: This constituent includes stearic acid or zinc stearate used as a manufacturing additive or a dye, calcium carbonate and saw dust as an expander for changing the material properties of the foam or showing the visual effects of the foam.

(4) Functional auxiliaries: This constituent could be an antistatic agent, a flame retardant or a reinforcing agent depending on the function of the foam.

While the invention has been described by means of specific embodiments, numerous modifications and variations could be made thereto by those skilled in the art without departing from the scope and spirit of the invention set forth in the claims.

1. A high multiple foam manufacturing method for thermoplastic elastomer composites, comprising the steps of:
using a thermoplastic elastomer as a composite of a substrate;
adding a foaming agent and a cross-linker of different functions;
performing a kneading process and a laminating process by traditional devices to produce a plurality of laminates with an appropriate size;
stacking said plurality of laminates with each other in a predetermined quantity according to an actual need;
sending said laminates into a first section of a hot compression mold to carry out a first-time compression mold foaming process; and
sending a pre-foaming cast so obtained into a second section of said hot compression mold or a rectangular oven to perform a second-time compression mold foaming process or a normal pressure foaming process to produce a high multiple foam.

2. The method of claim 1, wherein said thermoplastic elastomer uses a styrenic thermoplastic elastomer as a substrate.

3. The method of claim 2, wherein said styrenic thermoplastic elastomer is a Styrene Butadiene Styrene (SBS), a Styrene Ethylene Butene Styrene (SEBS) or a Styrene Isoprene Styrene (SIS) or a Styrene Ethylene Propylene Styrene (SEPS).

4. The method of claim 2, wherein said styrenic thermoplastic elastomer is approximately 50% to 100% by weight.

5. The method of claim 4, wherein said foaming agent is approximately 5% to 25% by weight.

6. The method of claim 5, wherein said foaming agent is a diazo foaming agent.

7. The method of claim 5, wherein said cross-linker is approximately 0.01% to 0.5% by weight.

8. The method of claim 7, wherein said cross-linker is dicumyl peroxide, 2,5-(tert-butylperoxide)-2,5-dimethylhexane, or a sulfur.

9. The method of claim 7, wherein said thermoplastic elastomer composites are placed in traditional devices according a predetermined percentage by weight, and said thermoplastic elastomer composites are kneaded, milled and mixed by said traditional devices at a temperature of approximately 90° C. to 130° C.

10. The method of claim 9, wherein said each thermoplastic elastomer composite after being mixed is sent into a two-roll laminating device for a milling process for a plurality of times and cut into a plurality of laminates with an appropriate size by an automatic knife after the laminates with a required thickness are formed.

11. The method of claim 10, wherein said steps of selecting said laminates with an appropriate weight according to actual needs, stacking said laminates with each other, and then putting said laminates into a hot compression mold, such that said laminates stacked by said hot compression mold at a temperature of approximately 140° C. to 180° C. and a pressure of approximately 90 to 250 Kg/cm² go through a first-time hot compression and a foaming process for an appropriate period of time to produce a desired pre-foaming cast.

12. The method of claim 11, wherein said foaming cast is putted into a second section of said hot compression mold with a predetermined specification when said foaming cast is still hot, such that said second section of said hot compression mold at a temperature of approximately 140° C. to 180° C. and a pressure of approximately 90 to 250 Kg/cm² goes through a foaming process and a second-time hot compression for an appropriate period of time to produce a high performance foam.

13. The method of claim 11, wherein said step of putting said foaming cast into a rectangular oven having a conveying function when said foaming cast is still hot, such that said rectangular oven performs a second-time foaming process at a temperature of approximately 140° C. to 180° C. and a normal pressure for said foaming cast for an appropriate time to produce a required high performance foam.

14. The method of claims 12, wherein said thermoplastic elastomer composite further comprises other polymer material, and said polymer material is approximately 0% to 50% by weight.

15. The method of claims 13, wherein said thermoplastic elastomer composite further comprises other polymer material, and said polymer material is approximately 0% to 50% by weight.

16. The method of claim 14, wherein said polymer material is a material made of Styrene Butadiene Rubber (SBR), Styrene (PS), Ethylene Vinyl Acetate (EVA), Low Density Polyethylene (LDPE) or Ethylene Propylene Terpolymer (EPDM).

17. The method of claim 15, wherein said polymer material is a material made of Styrene Butadiene Rubber (SBR), Styrene (PS), Ethylene Vinyl Acetate (EVA), Low Density Polyethylene (LDPE) or Ethylene Propylene Terpolymer (EPDM).

18. The method of claims 12, wherein said thermoplastic elastomer composite further comprises a foaming auxiliary, and said foaming auxiliary is approximately 0% to 3% by weight.

19. The method of claims 13, wherein said thermoplastic elastomer composite further comprises a foaming auxiliary, and said foaming auxiliary is approximately 0% to 3% by weight.

20. The method of claim 18, wherein said foaming auxiliary is zinc oxide or urea.

21. The method of claim 19, wherein said foaming auxiliary is zinc oxide or urea.

22. The method of claims 12, wherein said thermoplastic elastomer composite further comprises stearic acid or zinc stearate as other auxiliary.

23. The method of claims 13, wherein said thermoplastic elastomer composite further comprises stearic acid or zinc stearate as other auxiliary.

24. The method of claims 12, wherein thermoplastic elastomer composite further comprises a dye, calcium carbonate and saw dust as an expander.

25. The method of claims 13, wherein thermoplastic elastomer composite further comprises a dye, calcium carbonate and saw dust as an expander.

26. The method of claims 12, wherein said thermoplastic elastomer composite further comprises an antistatic agent, a flame retardant or a reinforcing agent as a functional auxiliary.

27. The method of claims 13, wherein said thermoplastic elastomer composite further comprises an antistatic agent, a flame retardant or a reinforcing agent as a functional auxiliary.
